(19) United States
(12) Patent Application Publication
(10) Pub. No.: US 2026/0201500 A1
(43) Pub. Date: Jul. 16, 2026

(54) FULL HYDROMETALLURGICAL PROCESS FOR RECOVERING MULTIPLE METALS FROM COMPLEX RARE AND PRECIOUS MATERIAL

(71) Applicants: COPPER BRANCH COMPANY OF YUNNAN TIN COMPANY LMITED, Honghe (CN); Kunming University of Science and Technology, Kunming (CN)

(72) Inventors: Yongchun LUO, Honghe (CN); Zihui MA, Honghe (CN); Feng YE, Honghe (CN); Bing CAI, Honghe (CN); Lei TAO, Honghe (CN); Rundong WANG, Honghe (CN); Yong YANG, Honghe (CN); Shaozeng PU, Honghe (CN); Xianhui ZHOU, Honghe (CN); Langlang WANG, Honghe (CN)

(21) Appl. No.: 19/561,499

(22) Filed: Mar. 9, 2026

Related U.S. Application Data
(63) Continuation of application No. PCT/CN2025/119573, filed on Sep. 8, 2025.

(30) Foreign Application Priority Data
Aug. 16, 2024 (CN) 202411128723.X

(51) Int. Cl. C22B 11/06; B01D 3/14; B01D 21/26; C01B 19/02; C22B 3/22; C22B 3/44; C22B 11/00; C22B 11/02

(52) U.S. Cl. CPC C22B 11/06; B01D 3/143; B01D 21/262; C01B 19/02; C22B 3/22; C22B 3/44; C22B 11/02; C22B 11/04

(57) ABSTRACT

A full hydrometallurgical process for recovering metals from complex rare-precious material includes: adding the material to hydrochloric acid solution, adding oxidant, filtering to obtain chloride solution and chloride residue; using two-stage countercurrent gold loading to obtain gold-loaded solution and post-loading solution, reducing the gold-loaded solution, clarifying and filtering to separate organic phase, post-reduction solution and sponge gold; evaporating and concentrating the post-reduction solution to produce concentrated solution 1 and condensate, cooling and crystallizing the concentrated solution, returning filtered residual oxalic acid to reduction process, and returning post-crystallization solution to gold-loading process; low-temperature distilling the post-loading solution to obtain concentrated solution 2; high-temperature distilling the concentrated solution 2 to obtain concentrated solution 3; performing directional crystallization and centrifugal filtration on the concentrated solution 3 to obtain crystallized residue and selenious acid; and washing crystallized residue with cold water or low-acid condensate, and filtering to obtain tellurium residue and palladium-platinum-rhodium-rich solution.

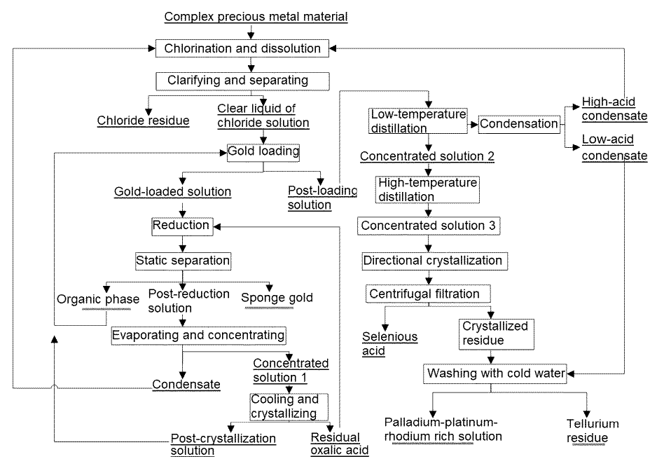

### CROSS REFERENCE TO RELATED APPLICATIONS

The present application is a continuation application of international application PCT/CN2025/119573 filed on Sep. 8, 2025, which international application claims priority to Chinese patent application number 202411128723.X filed with the Chinese Patent Office on Aug. 16, 2024, and entitled “FULL HYDROMETALLURGICAL PROCESS FOR RECOVERING MULTIPLE METALS FROM COMPLEX RARE AND PRECIOUS MATERIAL”, the entire contents of which are incorporated by reference herein.

### TECHNICAL FIELD

The present application belongs to the field of comprehensive recovery of rare and precious metals, and particularly relates to a full hydrometallurgical process for recovering multiple metals from a complex rare and precious material.

### BACKGROUND ART

During the non-ferrous metal smelting process, non-ferrous metals are enriched in the anode slime along with gold, platinum, palladium, rhodium, selenium, tellurium, etc., and after hydrometallurgical treatment of the anode slime, products co-enriched with gold, platinum, palladium, rhodium, selenium and tellurium are often produced, such as crude gold powder and platinum-palladium concentrate, which are intermediate products containing rare and precious metals and obtained by reducing the solution after gold extraction from the anode slime through chlorination.

Complex rare and precious materials containing gold, platinum, palladium, rhodium, selenium, and tellurium are treated by using the following conventional hydrometallurgical process: complex precious metal material-aqueous solution chlorination and dissolution-purification-reduction-gold powder (gold grade≤99.9%); ammonium chloropalladate method is used to precipitate platinum, palladium and part of rhodium from the post-reduction solution, and tellurium and selenium are then recovered separately from the post-reduction solution. The conventional process may well separate tellurium, bismuth and precious metals, but there are problems as follows.

First, the low dissolution rates of platinum, palladium, and rhodium during the chlorination gold separation process leads to dispersion, making enrichment difficult and subsequent recovery rates low.

Second, the chloride residue is difficult to filter, and gold, platinum, palladium, and rhodium are entrained and lost.

Third, the gold extraction wastewater is difficult to treat, requiring the addition of a large amount of neutralizing agent to produce neutralization residue containing gold, platinum and palladium, and the neutralized high-chloride salt-containing wastewater cannot be recycled.

### SUMMARY

One or more embodiments of the present application provide a full hydrometallurgical process for recovering multiple metals from a complex rare and precious material, including the following steps:
step 1: chlorination and dissolution: adding a hydrochloric acid aqueous solution and the complex rare and precious material to a reactor, stirring for reaction during which a temperature is raised to 60-70° C. and an oxidant is added slowly, adding a small amount of the complex rare and precious material again after the reaction is completed, stirring to remove chlorine, stopping stirring for clarification, then extracting the upper clear liquid of the chloride solution for entering gold loading (i.e., gold loading step), where the precipitated chloride residue is used as the raw material for silver recovery; where the technical conditions are controlled as: concentration of the hydrochloric acid aqueous solution of 5-7 mol/L, liquid-to-solid ratio of 3-6:1, and oxidation process temperature of 80-95° C.;
step 2: gold loading: performing two-stage countercurrent gold loading to obtain a gold-loading solution and a post-uploading solution after loading of the chloride solution, performing reduction on the gold-loading solution, performing static separation when reaching the end point of the reduction for clarifying to separate the organic phase, and filtering the precipitate to separate the post-reduction solution and sponge gold; and evaporating and concentrating the post-reduction solution to produce a concentrated solution 1 and a condensate;
step 3: cooling the concentrated solution 1 in step 2 to <30° C., stirring for crystallizing, and filtering to obtain a post-crystallization solution and residual oxalic acid, where the post-crystallization solution is returned to the gold loading process in step 2, and the residual oxalic acid is returned to the reduction process of the gold-loaded solution in step 2;
step 4: low-temperature distillation: performing low-temperature distillation on the post-loading solution in step 2 to distill out a low-acid condensate and a high-acid condensate, where the high-acid condensate is returned to step 1 as a hydrochloric acid input, and the low-acid condensate enters step 6 for washing, and the post-distillation residual solution is a concentrated solution 2;
step 5: high-temperature distillation: performing high-temperature distillation on the concentrated solution 2 in step 4 to remove residual moisture to obtain a concentrated solution 3;
step 6: directional crystallization and centrifugal filtration: performing directional crystallization and centrifugal filtration on the concentrated solution 3 to obtain crystallized residue and selenious acid; and
step 7: washing: washing the crystallized residue with cold water or the low-acid condensate produced in step 4, and filtering to obtain tellurium residue and palladium-platinum-rhodium rich solution.

In one or more embodiments, in step 1, components of the complex rare and precious material include, by mass percentage, selenium 3-20%, tellurium 3-40%, gold≥1%, platinum≥0.1%, palladium≥0.1%, rhodium≥0.005%, and other impurities<30%.

In one or more embodiments, selenium, tellurium, gold, platinum, palladium, and rhodium each exist in the form of elemental phase.

In one or more embodiments, in step 1, the oxidant is perchloric acid.

In one or more embodiments, in step 1, the concentration of the oxidant is 26-30%.

In one or more embodiments, in step 1, the oxidant is added in an amount of 2.5-4 times the total amount of gold, selenium, and tellurium in the material added.

In one or more embodiments, in step 2, the specific operation of the gold loading includes: controlling the flow rate ratio of the loading agent to the chloride solution to be 1:0.8~8, performing countercurrent gold loading by using the loading counter tower 1 (i.e., extraction tower 1) and the loading tower 2 (i.e., extraction tower 2) and adopting a two-stage loading reactor to obtain a gold-loaded solution and a post-loading solution after the loading, sending the gold-loaded solution to a reduction reactor for reduction, and performing static separation when reaching the end point of reduction, standing for 10 min or above for clarifying to separate the organic phase, and filtering the precipitate to separate the post-reduction solution and sponge gold; and evaporating and concentrating the post-reduction solution to produce a concentrated solution 1 and a condensate; and returning the concentrated solution 1 to the reduction process, and returning the condensate to step 1 to supplement the hydrochloric acid aqueous solution.

In one or more embodiments, the loading agent is a mixture of methyl isobutyl ketone (MIBK) and TBP (tributyl phosphate).

In one or more embodiments, the diluent is a mixture of chloroform and one or two of n-dodecane and sulfonated kerosene.

In one or more embodiments, in step 2, the two-stage loading reactor includes a first-stage loading reactor and a second-stage loading reactor.

In one or more embodiments, a potentiometer is mounted at the aqueous phase outlet of the first-stage loading reactor to monitor the potential value of the aqueous phase.

In one or more embodiments, when the potential value drops to <520 mV, the introduction of the chloride solution is stopped, and at this time, the first-stage gold-loaded solution is pumped to the reduction reactor for reduction, and the second-stage loading reactor is switched to be the first-stage loading reactor.

In one or more embodiments, in step 2, the gold-loaded solution is fed into a reactor for reduction.

In one or more embodiments, in step 2, the reduction temperature is 90-95° C.

In one or more embodiments, in step 2, the gold-loaded solution at the reduction end point of the reduction contains<0.1 g/L of gold; and the reducing agent is oxalic acid.

In one or more embodiments, in step 4, during the low-temperature distillation, the temperature of the liquid in the low-temperature distillation tower is controlled to be 60-75° C.

In one or more embodiments, in step 4, during the low-temperature distillation, the pressure in the low-temperature distillation tower is controlled to be 55-65 kPa.

In one or more embodiments, in step 5, the temperature of the high-temperature distillation is 90-100° C.

In one or more embodiments, in step 5, the pressure in the evaporator for the high-temperature distillation is 60-80 kPa.

In one or more embodiments, in step 6, the temperature of the directional crystallization is 75-80° C.

### BRIEF DESCRIPTION OF DRAWINGS

In order to more clearly illustrate the technical solutions of the embodiments of the present application or in the prior art, the drawings required for use in description of the embodiments or the prior art will be briefly introduced below. Obviously, the drawings described below are merely embodiments of the present application. For a person ordinarily skilled in the art, other drawings may be obtained based on the provided drawings without paying any creative work.

The sole FIGURE is a flow chart of a full hydrometallurgical process for recovering multiple metals from a complex rare and precious material disclosed in the present application.

### DETAILED DESCRIPTION OF EMBODIMENTS

The following describes embodiments of the present application. Examples of the embodiments are shown in the drawings. The embodiments described with reference to the drawings are exemplary and are intended to be used to explain the present application, but are not to be construed as limitations on the present application.

The present application discloses a full hydrometallurgical process for recovering multiple metals from a complex rare and precious material, where the aqueous phase system is free of sodium salts, cyanides, nitrogen oxides and sulfides, creates conditions for the coordination of ion exchange technology with distillation and concentration, realizes the regeneration and recycling of hydrochloric acid and water, produces gold powder with a gold content of more than 99.99%, enables high enrichment ratios of these metals (the liquid phase enrichment ratio of precious metals after dissolution exceeding 30) obtained by treating the rare and precious material containing precious metals, especially platinum, palladium and rhodium of relatively low contents, and achieves no wastewater generation in the whole flow process, short process flow and high recovery rate of precious metals.

In order to achieve the above purposes, the present application adopts the following technical solutions:
step 1: chlorination and dissolution: adding a hydrochloric acid aqueous solution and a complex rare and precious material to a reactor, stirring for reaction during which a temperature is raised to 60-70° C. and an oxidant is slowly added, adding a small amount of the complex rare and precious material again after the reaction is completed, stirring to remove chlorine, stopping stirring for clarification, then extracting the upper clear liquid of the chloride solution for entering the gold loading (i.e., the gold loading step), where the precipitated chloride residue is used as the raw material for silver recovery; where the technical conditions are controlled as follows: concentration of the hydrochloric acid aqueous solution of 5-7 mol/L, liquid-to-solid ratio of 3-6:1, and oxidation process temperature of 80-95° C.;
step 2: gold loading: performing two-stage countercurrent gold loading to obtain a gold-loading solution and a post-uploading solution after loading of the chloride solution, performing reduction on the gold-loading solution, performing static separation when reaching the end point of reduction for clarifying to separate the organic phase, and filtering the precipitate to separate the post-reduction solution and sponge gold; and evaporating and concentrating the post-reduction solution to produce a concentrated solution 1 and a condensate;
step 3: cooling the concentrated solution 1 in step 2 to <30° C., stirring for crystallizing, and filtering to obtain a post-crystallization solution and residual oxalic acid, where the post-crystallization solution is returned to the gold loading process in step 2, and the residual oxalic acid is returned to the reduction process of the gold-loaded solution in step 2;
step 4: low-temperature distillation: performing low-temperature distillation on the post-loading solution in step 2 to distill out a low-acid condensate and a high-acid condensate, where the high-acid condensate is returned to step 1 as a hydrochloric acid input, and the low-acid condensate enters step 6 for washing, and the post-distillation residual solution is a concentrated solution 2;
step 5: high-temperature distillation: performing high-temperature distillation on the concentrated solution 2 in step 4 to remove residual moisture to obtain a concentrated solution 3;
step 6: directional crystallization and centrifugal filtration: performing directional crystallization and centrifugal filtration on the concentrated solution 3 to obtain crystallized residue and selenious acid; and
step 7: washing: washing the crystallized residue with cold water or the low-acid condensate produced in step 4, and filtering to obtain tellurium residue and palladium-platinum-rhodium rich solution.

The chemical equation for the reaction in step 1 is as follows.

$$7 Au + 3 {HClO}_{4} + 25 {Cl}^{-} + 21 {H}^{-} = {7 [ {AuCl}_{4} ]}^{- 1} + 12 {H}_{2} O .$$

The beneficial effects are that it may avoid the problems of long reaction time and poor on-site environment brought about by dechlorination operations in the chlorination and dissolution process of other technologies; by retaining the chloride residue for re-chlorination, improve the gold leaching effect during chlorination and dissolution, reduce the number of filtration times of the chloride residue, and avoid gold loss in the filtration process.

In one or more embodiments, in step 1, the components of the complex rare and precious material include, by mass percentage, selenium 3-20%, tellurium 3-40%, gold≥1%, platinum≥0.1%, palladium≥0.1%, rhodium≥0.005%, and other impurities<30%.

In one or more embodiments, selenium, tellurium, gold, platinum, palladium, and rhodium each exist in the form of elemental phase.

In one or more embodiments, in step 1, the oxidant is perchloric acid.

In one or more embodiments, in step 1, the concentration of the oxidant is 26-30%.

In one or more embodiments, in step 1, the oxidant is added in an amount of 2.5-4 times the total amount of gold, selenium, and tellurium in the material added.

In one or more embodiments, in step 2, the specific operation of the gold loading includes: controlling the flow rate ratio of the loading agent to the chloride solution to be 1:0.8~8, performing countercurrent gold loading by using the loading counter tower 1 (i.e. extraction tower 1) and the loading tower 2 (i.e., extraction tower 2) and adopting a two-stage loading reactor to obtain a gold-loaded solution and a post-loading solution after the loading, sending the gold-loaded solution to a reduction reactor for reduction, and performing static separation when reaching the end point of reduction, standing for 10 min or above for clarifying to separate the organic phase, and filtering the precipitate to separate the post-reduction solution and sponge gold; and evaporating and concentrating the post-reduction solution to produce a concentrated solution 1 and a condensate; and returning the concentrated solution 1 to the reduction process, and returning the condensate to step 1 to supplement the hydrochloric acid aqueous solution.

In one or more embodiments, the loading agent is a mixture of methyl isobutyl ketone (MIBK) and TBP.

In one or more embodiments, the diluent is a mixture of chloroform and one or two of n-dodecane and sulfonated kerosene.

In one or more embodiments, in step 2, the two-stage loading reactor includes a first-stage loading reactor and a second-stage loading reactor.

In one or more embodiments, a potentiometer is installed at the aqueous phase outlet of the first-stage loading reactor to monitor the potential value of the aqueous phase.

In one or more embodiments, when the potential value drops to <520 mV, the introduction of the chloride solution is stopped, and at this time, the first-stage gold-loaded solution is pumped to the reduction reactor for reduction, and the second-stage loading reactor is switched to be the first-stage loading reactor.

The loading reaction is as follows.

$$R + {HAuCl}_{4} = [ {R H}^{+} ] [ {AuCl}_{4}^{-} ] .$$

In one or more embodiments, in step 2, the reduction temperature is 90-95° C. in step 2, the gold-loaded solution at the reduction end point of the reduction contains<0.1 g/L of gold; and the reducing agent is oxalic acid.

The reduction reaction is as follows.

$$3 {H}_{2} {C}_{2} {O}_{4} + 2 [ {R H}^{+} ] [ {AuCl}_{4}^{-} ] = 2 Au + 6 {CO}_{2} + 8 {H}^{+} + 8 Cl + 2 R .$$

In one or more embodiments, in step 4, during the low-temperature distillation, the temperature of the liquid in the low-temperature distillation tower is controlled to be 60-75° C.

In one or more embodiments, in step 4, during the low-temperature distillation, the pressure in the low-temperature distillation tower is controlled to be 55-65 kPa.

In one or more embodiments, in step 5, the temperature of the high-temperature distillation is 90-100° C.

In one or more embodiments, in step 5, the pressure in the evaporator of the high-temperature distillation is 60-80 kPa.

In one or more embodiments, in step 6, the temperature of directional crystallization is 75-80° C.

The principle of directional crystallization is as follows: after the high-temperature distillation, the post-loading solution is distilled to dry to remove the free water and hydrochloric acid, and the remaining parts are platinum chloride, palladium chloride, rhodium chloride, tellurium chloride and selenious acid; when the temperature drops to 75~80° C., except for selenious acid, the others precipitate in the form of solids. Directed crystallization enables the precious metals and tellurium to be separated from selenium.

The crystallized residue is washed with cold water to dissolve the soluble precious metal salts into the palladium-platinum-rhodium rich solution, achieving the separation from tellurium.

The obtained palladium-platinum-rhodium rich solution, with high precious metal concentration and tellurium impurity, may be served as a liquid raw material for the separation and purification of palladium, platinum and rhodium, and processes of palladium extraction, platinum extraction, and reductive precipitation of rhodium may be used to separate and purify palladium, platinum and rhodium to obtain corresponding products or high-grade concentrates.

Compared with the prior art, the present application has the following beneficial effects.
(1) The present application proposes a zero-discharge technology for wastewater, i.e., there are no sodium salts, no cyanides, no nitrogen oxides, and no sulfides in the aqueous phase system, creating conditions for the coordination of ion exchange technology with distillation and concentration, and realizing the regeneration and recycling of hydrochloric acid and water.
(2) The present application has strong adaptability to the components of the complex material containing gold, platinum, palladium, rhodium, selenium, and tellurium, and is particularly suitable for materials with high selenium and tellurium contents and low precious metal contents, can obtain high direct recovery rates and recovery, and can separate selenium and tellurium from the solution to obtain a precious solution with high concentrations of platinum, palladium, rhodium and rhodium, facilitating further extraction of these metals.

In order to better understand the present application, the present application will be further specifically described below through the following examples, but it should not be understood as a limitation of the present application. Some non-essential improvements and adjustments made by the person skilled in the art based on the above invention content are also considered to fall within the scope of protection of the present application.

### Example 1

100 kg of a rare and precious material containing selenium 3.0%, tellurium 37.3%, gold 1.16%, platinum 0.107%, palladium 0.31%, and rhodium 0.0052% were fed, and the operating steps of Example 1 were as follows:
step 1: chlorination and dissolution: adding 355 kg of 36% hydrochloric acid to the reactor at a liquid-to-solid ratio of 5:1, and then adding water to prepare 500 ml of 7 mol/L hydrochloric acid solution, then starting the agitator, slowly adding the complex rare and precious material, stirring, heating to 60° C., slowly adding 47 kg of 28% perchloric acid, controlling the oxidation temperature at 82° C., adding 3 kg of the complex rare and precious material after the reaction was completed, then stirring to eliminate chlorine, stopping stirring for clarifying, extracting the upper clear liquid of the chloride solution for entering the gold loading (i.e. the gold loading step), and retaining the precipitated chloride residue in the reactor for further chlorination and dissolution with the next batch of material, cycling twice in sequence, then filtering to obtain 3.2 kg of chloride residue which was used as the raw material for silver recovery, where the weight composition of the chloride residue was: gold 0.188%, platinum 0.066%, palladium 0.0165%, rhodium 0.0012%, tellurium 11.73%, selenium 1.65%, silver 28.67%, and lead 7.35%, and 461 L of clear liquid of the chloride solution was produced (containing gold 2.59 g/L, platinum 0.234 g/L, palladium 0.693 g/L, rhodium0.0112 g/L, tellurium 82.7 g/L, and selenium 6.61 g/L);
step 2: gold recovery: preparing the loading agent at a ratio of MIBK:TBP: sulfonated kerosene:chloroform of 30%: 10%: 50%: 10%, performing a two-stage (the first stage and the second stage) countercurrent gold loading on the chloride solution in step 1 at a flow rate ratio of loading agent to chloride solution of 1:8, mounting a potentiometer at the aqueous phase outlet of the first loading reactor to monitor the potential value of the aqueous phase, stopping the introduction of the chloride solution when the potential value drops to 508 mV, where at this time, the first-stage gold-loaded solution was pumped to the reduction reactor for reduction, and the second-stage loading was switched to be the first-stage loading; obtaining 58 L of a gold-loaded solution and 460.6 L of a post-loading solution after the loading, sending the gold-loaded solution containing gold 20.58 g/L and platinum, palladium, and rhodium all<0.001 g/L to the reducer (reduction reactor) for reduction, where the reducing agent was oxalic acid and prepared into 20 L of 80 g/L oxalic acid solution, the reduction temperature was 90° C., and at the end point of the reduction, the gold-loaded solution contained 0.01 g/L gold; performing static separation when reaching the end point of reduction, standing for 10 min or above to separate the organic phase, and performing filtering separation on the crude gold powder mixed with the post-reduction solution to separate 19.5 L of post-reduction solution and 1.192 kg of sponge gold, with a gold grade of 99.996%, sending the post-reduction solution to the evaporator for evaporating and concentrating to produce a concentrated solution 1 (3 L) and a condensate (16 L), returning the concentrated solution 1 to the reduction process, and returning the condensate to step 1;
step 3: cooling the concentrated solution 1 to 26° C., stirring for crystallization, filtering to obtain a post-crystallization solution and residual oxalic acid, where the post-crystallization solution was returned to the gold loading process in step 2, and the residual oxalic acid was returned to the reduction process of the gold-loaded solution in step 2;
step 4: low-temperature distillation: pumping the post-loading solution in step 2 to the low-temperature vacuum evaporator, controlling the temperature of the liquid in the low-temperature distillation tower to 65° C. and the pressure in the distillation tower to 55 kPa, and distilling out 143.2 L of a low-acid condensate (containing gold 0.0001 g/L, platinum 0.0001 g/L, palladium 0.0001 g/L, rhodium 0.0001 g/L, tellurium 2.2 g/L, selenium) and 113 L of a high-acid condensate (containing gold<0.0001 g/L, palladium<0.0001 g/L, rhodium<0.0001 g/L, tellurium 2.21 g/L, selenium 0.1 g/L, H+ 2.6 g/L), where the high-acid condensate was returned to step 1 as the hydrochloric acid input, and the low-acid condensate entered step 6 for washing, and a concentrated solution 2 (204.4 L) was produced, containing gold 0.0026 g/L, platinum 0.527 g/L, palladium 1.56 g/L, rhodium 0.0251 g/L, tellurium 184.86 g/L, and selenium 14.77 g/L;
step 5: high-temperature distillation: transferring the concentrated solution 2 in step 4 to a high-temperature evaporator, further raising the temperature to 96° C., and controlling the pressure inside the evaporator to 68 kPa to remove the residual moisture until crystals were formed, to produce a concentrated solution 3;
step 6: directional crystallization and centrifugal filtration: discharging the concentrated solution 3 (63 L) discharged in step 5 and containing gold 0.0017 g/L, platinum 1.705 g/L, palladium 4.93 g/L, rhodium 0.079 g/L, tellurium 585.93 g/L, and selenium 45.0 g/L, and cooling to 76° C. for directional crystallization; performing centrifugal filtration to obtain 58.45 kg of crystallized residue (containing gold 0.0002%, platinum 0.184%, palladium 0.53%, rhodium 0.0084%, tellurium 62.78%, and selenium 0.39%) and 4.3 L of selenious acid (containing gold 0.0004 g/L, platinum 0.04 g/L, palladium 0.159 g/L, and rhodium 0.0067 g/L, tellurium 50.64 g/L, selenium 606.25 g/L); and
step 7: washing the crystallized residue in step 6 with cold water or the low-acid condensate produced in step 4, with the pH controlled to 2-3 during the washing process, filtering after the washing to obtain 63.4 kg of tellurium residue (containing gold<0.0001%, platinum<0.0001, palladium 0.001%, rhodium<0.0001%, tellurium 56.55%, and selenium 0.19%) and a palladium-platinum-rhodium rich solution (containing gold 0.004 g/L, platinum 4.52 g/L, palladium 13.11 g/L, rhodium 0.209 g/L, tellurium 35.76 g/L, and selenium 4.491 g/L).

### Comparative Example 1: Implementation Method

for the components of the waste acid treated in Example 1, the process of dissolution by using an aqueous solution chlorination method to obtain a chloride solution containing precious metals-neutralization to adjust pH-gold precipitation by reduction-ammonium chloropalladate precipitation of platinum and palladium was carried out with the specific operation steps as follows:
(1) adding 60 g/L hydrochloric acid and 15 kg of sodium chlorate at a liquid-to-solid ratio of 5:1, stirring at the temperature controlled at 95° C. for 4 h for dissolution to obtain 452 L of chloride solution (containing gold 2.46 g/L, palladium 0.65 g/L, platinum 0.33 g/L, rhodium 0.01 g/L, selenium 5.37 g/L, and tellurium 79.72 g/L) and 18.6 kg of chloride residue (gold 0.477%, palladium 0.14%, rhodium 0.0037%, platinum 0.033%, tellurium 13.24%, and selenium 3.51%);
(2) neutralizing the chloride solution obtained in step (1) to pH-3 by adding sodium hydroxide, and filtering to obtain 449 L of neutralized solution (containing gold 2.2 g/L, platinum 0.22 g/L, palladium 0.63 g/L, rhodium 0.01 g/L, tellurium 75.84 g/L, and selenium 5.38 g/L), and 3.4 kg of neutralization residue containing gold 2.05%, platinum 0.153%, palladium 0.322%, rhodium 0.0009%, tellurium 58.3%, and selenium 0.34%;
(3) heating the neutralized solution produced in step (2) to 86-90° C., adding 0.3 kg of oxalic acid for reduction to obtain about 0.988 kg of gold powder with a gold grade of 99.9% and produce 445 L of post-reduction solution; and
(4) slowly adding 8 kg of sodium chlorate to the post-reduction solution produced in step (3), at the temperature controlled at 57° C., to produce 1.0 kg of ammonium chloropalladate containing gold 0.28%, platinum 7.78%, palladium 24.72%, rhodium 0.169%, tellurium 3.4%, and selenium 1.1%, and produce 445 L of post-palladium-precipitation solution containing gold 0.519 g/L, platinum 0.061 g/L, palladium 0.08 g/L, rhodium 0.0063 g/L, tellurium 76.45 g/L, and selenium 5.1 g/L.

### Effect Comparison of Example 1

Example 1 recovered and produced 99.99% gold powder from the rare and precious metal material containing selenium 3.0%, tellurium 37.3%, gold 1.16%, platinum 0.107%, palladium 0.31%, and rhodium 0.0052%, and recovered and obtained a palladium-platinum-rhodium rich solution. The metal direct recovery rates are as shown in Table 1, where the metal direct recovery rates and recovery rate indicators in Example 1 are comprehensively superior to those in Comparative Example 1. In addition, by using the method of Example 1, no reagents, such as nitric acid, cyanide, sulfur dioxide, and alkali, are used, truly achieving the regeneration and reuse of acid and accomplishing the goal of zero discharge. Specific implementation technical and economic indicators are presented in Table 1.

TABLE 1
Comparison of Effects of Example 1 and Comparative Example 1

| | Direct recovery rate/% | | | | | |
|---|---|---|---|---|---|---|
| | | Pt | Pd | Rh | | |
| | | (palladium- | (palladium- | (palladium- | | |
| | Au | platinum- | platinum- | platinum- | Se | Te |
| | (sponge | rhodium rich | rhodium rich | rhodium rich | (selenious | (tellurium |
| Item | gold) | solution) | solution) | solution) | acid) | residue) |
| Example 1 | 99.4 | 97.3 | 96.8 | 949 | 84.2 | 93.2 |
| Comparative | 67.0 (sponge | 70.7 (ammonium | 77.3 (ammonium | 32.6 (ammonium | 72.8 (post- | 88.4 (post- |
| Example 1 | gold) | chloropalladate) | chloropalladate) | chloropalladate) | palladium- | palladium- |
| | | | | | precipitation | precipitation |
| | | | | | solution) | solution) |

### Example 2

For 100 kg of a rare and precious material containing selenium 11.9%, tellurium 17.8%, gold 15.0%, platinum 0.146%, palladium 11.93%, and rhodium 0.0064%, the operating steps of Example 2 were as follows:
step 1: chlorination and dissolution: adding 182.5 kg of 36% hydrochloric acid at a liquid-to-solid ratio of 3:1, adding water to the reactor to prepare 300 L of a hydrochloric acid solution containing 6 mol/L hydrochloric acid, starting stirring, slowly adding the complex rare and precious material, stirring, heating to 65° C., slowly adding 43 kg of 26% perchloric acid, controlling the temperature of oxidation process at 88° C., adding 3 kg of the complex rare and precious material after the reaction was completed, stirring to eliminate chlorine, stopping stirring for clarifying, extracting the upper clear liquid of the chloride solution for entering the gold loading, retaining the precipitated chloride residue in the reactor for further chlorination and dissolution with the next batch of material, cycling for three times in sequence, then filtering to obtain 2.7 kg of chloride residue which was used as the raw material for silver recovery, where the components of filtered chloride residue were: gold 0.41%, platinum 0.0011%, palladium 0.0957%, rhodium 0.0041%, tellurium 11.65%, selenium 1.82%, silver 29.2%, and lead 3.51%, and 296 L of clear liquid of the chloride solution was produced (containing gold 41.52 g/L, platinum 0.51 g/L, palladium 4.147 g/L, rhodium 0.0065 g/L, tellurium 60.76 g/L, and selenium 41.39 g/L).
step 2: gold recovery: preparing the loading agent at a ratio of MIBK:TBP: sulfonated kerosene:chloroform of 35%: 5%: 55%: 5%, performing a two-stage (the first stage and the second stage) countercurrent gold loading on the chloride solution in step 1 at a flow rate ratio of loading agent to chloride solution of 1:6, mounting a potentiometer at the aqueous phase outlet of the first loading reactor to monitor the potential value of the aqueous phase, stopping the introduction of the chloride solution when the potential value drops to 512 mV, where at this time, the first-stage gold-loaded solution was pumped to the reduction reactor for reduction, and the second-stage loading was switched to be the first-stage loading; obtaining 164 L of a gold-loaded solution and 295 L of a post-loading solution after the loading, sending the gold-loaded solution containing gold 74.87 g/L and platinum, palladium, and rhodium all<0.001 g/L to the reducer (reduction reactor) for reduction, where the reducing agent was oxalic acid and prepared into 50 L of 85 g/L oxalic acid solution, the reduction temperature was 92° C., and at the end point of the reduction, the gold-loaded solution contained 0.007 g/L gold; performing static separation when reaching the end point of reduction, standing for 10 min or above to separate the organic phase, performing filtering separation on the crude gold powder mixed with the post-reduction solution to separate 49.6 L of post-reduction solution and 12.28 kg of sponge gold, with a gold grade of 99.996%, sending the post-reduction solution to the evaporator for evaporating and concentrating to produce a concentrated solution 1 (8 L) and a condensate (41 L), returning the concentrated solution 1 to the reduction process, and returning the condensate to step 1;
step 3: cooling the concentrated solution 1 to 25° C., stirring for crystallization, filtering to obtain a post-crystallization solution and residual oxalic acid, where the post-crystallization solution was returned to the gold loading process in step 2, and the residual oxalic acid was returned to the reduction process of the gold-loaded solution in step 2;
step 4: low-temperature distillation: pumping the post-loading solution in step 2 to the low-temperature vacuum evaporator, controlling the temperature of the liquid in the low-temperature distillation tower to 70° C. and the pressure in the distillation tower to 61 kPa, and distilling out 124 L of a low-acid condensate (containing gold 0.0001 g/L, platinum 0.0001 g/L, palladium 0.0001 g/L, rhodium 0.0001 g/L, tellurium 0.876 g/L, selenium 0.877 g/L) and 104 L of a high-acid condensate (containing gold<0.0001 g/L, palladium<0.0001 g/L, rhodium<0.0001 g/L, tellurium 1.34 g/L, selenium 1.41 g/L, H+2.6 g/L), where the high-acid condensate was returned to step 1 as the hydrochloric acid input, and the low-acid condensate entered step 6 for washing, and a concentrated solution 2 (67 L) was produced, containing gold 0.0147 g/L, platinum 2.227 g/L, palladium 18.31 g/L, rhodium 0.096 g/L, tellurium 263.67 g/L, and selenium 178.67 g/L;
step 5: high-temperature distillation: transferring the concentrated solution 2 in step 4 to a high-temperature evaporator, further raising the temperature to 96° C., and controlling the pressure inside the evaporator to 68 kPa to remove the residual moisture until crystals were formed, to produce a concentrated solution 3;
step 6: directional crystallization and centrifugal filtration: discharging the concentrated solution 3 (32 L) discharged in step 5 and containing gold 0.306 g/L, platinum4.66 g/L, palladium 38.245 g/L, rhodium 0.200 g/L, tellurium 545.35 g/L, and selenium 372.67 g/L, and cooling to 73° C. for directional crystallization; performing centrifugal filtration to obtain 27.36 kg of crystallized residue (containing gold 0.035%, platinum 0.544%, palladium 4.467%, rhodium 0.023%, tellurium 63.407%, and selenium 3.504%) and 16.83 L of selenious acid (containing gold 0.0004 g/L, platinum 0.04 g/L, palladium 0.159 g/L, and rhodium 0.0067 g/L, tellurium 50.64 g/L, selenium 606.25 g/L); and
step 7: washing the crystallized residue in step 6 with cold water or the low-acid condensate produced in step 4, with the pH controlled to 2-3 during the washing process, filtering after the washing to obtain 63.4 kg of tellurium residue (containing gold<0.0001%, platinum<0.0001, palladium 0.001%, rhodium<0.0001%, tellurium 56.55%, and selenium 0.19%) and a palladium-platinum-rhodium rich solution (containing gold 0.004 g/L, platinum 4.52 g/L, palladium 13.11 g/L, rhodium 0.209 g/L, tellurium 35.76 g/L, and selenium 4.491 g/L).

### Comparative Example 2: Implementation Method

for the components of the waste acid treated in Example 2, the process of dissolution by using an aqueous solution chlorination method to obtain a chloride solution containing precious metals-neutralization to adjust pH-gold precipitation by reduction-ammonium chloropalladate precipitation of platinum and palladium was carried out with the specific operation steps as follows:
(1) adding 80 g/L hydrochloric acid and 15 kg of sodium chlorate at a liquid-to-solid ratio of 3:1, stirring at the temperature controlled at 95° C. for 4 h for dissolution to obtain 297 L of chloride solution (containing gold 48.9 g/L, palladium 3.84 g/L, platinum 0.463 g/L, rhodium 0.0197 g/L, selenium 32.14 g/L, and tellurium 56.87 g/L) and 16.3 kg of chloride residue (gold 5.99%, palladium 0.551%, rhodium 0.0046%, platinum 0.076%, tellurium 8.64%, and selenium 16.9%);
(2) neutralizing the chloride solution obtained in step (1) to pH=2 by adding sodium hydroxide, and filtering to obtain 278 L of neutralized solution (containing gold 51.96 g/L, palladium 4.212 g/L, platinum 0.514 g/L, rhodium 0.0236 g/L, tellurium 61.746 g/L, and selenium 5.38 g/L), and 4.8 kg of neutralization residue containing gold 21.95%, palladium 4.7%, platinum 0.15%, rhodium 0.0011%, tellurium 23.64%, and selenium 0.34%;
(3) heating the neutralized solution produced in step (2) to 90° C., adding 5 kg of oxalic acid for reduction to obtain about 14.446 kg of gold powder with a gold grade of 99.9% and produce 273 L of post-reduction solution; and
(4) slowly adding 6 kg of sodium chlorate to the post-reduction solution produced in step (3), at the temperature controlled at 59° C., to produce 4.2 kg of ammonium chloropalladate containing gold 0.281%, palladium 24.73%, platinum 3.0%, rhodium 0.083%, tellurium 0.41%, and selenium 0.22%, and produce post-palladium-precipitation solution containing gold 1.86 g/L, platinum 0.06 g/L, palladium 0.49 g/L, rhodium 0.011 g/L, tellurium 63.517 g/L, and selenium 34.7 g/L.

### Effect Comparison of Example 2

From a rare and precious material containing selenium 11.9%, tellurium 17.8%, gold 15.0%, platinum 0.146%, palladium 11.93%, and rhodium 0.0064, 99.99% gold powder was recovered and produced and a palladium-platinum-rhodium rich solution was recovered and obtained. The metal direct recovery rates are as shown in Table 2, where the metal direct recovery rates and recovery rate indicators in Example 2 are comprehensively superior to those in Comparative Example 2. In addition, by using the method of Example 2, no reagents, such as nitric acid, cyanide, sulfur dioxide and alkali, are used, truly achieving the regeneration and reuse of acid and accomplishing the goal of zero discharge. Specific implementation technical and economic indicators are presented in Table 2.

TABLE 2
Comparison of Effects of Example 2 and Comparative Example 2

| | Direct recovery rate/% | | | | | |
|---|---|---|---|---|---|---|
| | | Pt | Pd | Rh | | |
| | | (palladium- | (palladium- | (palladium- | | |
| | Au | platinum- | platinum- | platinum- | Se | Te |
| | (sponge | rhodium rich | rhodium rich | rhodium rich | (selenious | (tellurium |
| Item | gold) | solution) | solution) | solution) | acid) | residue) |
| Example 2 | 99.9 | 98.9 | 99.3 | 95.8 | 89.3 | 92.7 |
| Comparative | 89.9 (sponge | 84.2 (ammonium | 84.5 (ammonium | 53.0 (ammonium | 76.2 (post- | 93.7 post- |
| Example 2 | gold) | chloropalladate) | chloropalladate) | chloropalladate) | palladium- | palladium- |
| | | | | | precipitation | precipitation |
| | | | | | solution) | solution) |

### Example 3

For 100 kg of a rare and precious material containing selenium 19.2%, tellurium 3.2%, gold 51.1%, platinum 0.35%, palladium 2.17%, and rhodium 0.0071%, the operating steps of Example 3 were as follows:
step 1: chlorination and dissolution: adding 365 kg of 36% hydrochloric acid at a liquid-to-solid ratio of 6:1, adding water to the reactor to prepare 600 L of a hydrochloric acid solution containing 6 mol/L hydrochloric acid, starting stirring, slowly adding the complex rare and precious material and stirring, i.e., adding the hydrochloric acid-containing aqueous solution and the complex rare and precious material in the reactor and performing stirring for reaction; heating to 70° C., slowly adding 48 kg of 30% perchloric acid, where the temperature of oxidation process was controlled at 95° C.; adding 3 kg of the complex rare and precious material after the reaction was completed, stirring to eliminate chlorine, stopping stirring and performing clarifying, extracting the upper clear liquid of the chloride solution for entering the gold loading, retaining the precipitated chloride residue in the reactor for further chlorination and dissolution with the next batch of material, cycling for four times in sequence, then filtering to obtain 2.4 kg of chloride residue which was used as the raw material for silver recovery, where components of the filtered chloride residue were: gold 1.98%, platinum 0.003%, palladium 0.196%, rhodium 0.005%, tellurium 2.37%, selenium 3.3%, silver 34.1%, and lead 2.92%, and 597 L of clear liquid of the chloride solution was produced (containing gold 88.20 g/L, platinum 0.60 g/L, palladium 3.74 g/L, rhodium 0.012 g/L, tellurium 5.43 g/L, and selenium 33.03 g/L);
step 2: gold recovery: preparing the loading agent at a ratio of MIBK:TBP: sulfonated kerosene:chloroform of 40%: 5%: 50%: 5%, performing a two-stage (the first stage and the second stage) countercurrent gold loading on the chloride solution in step 1 with at a flow rate ratio of loading agent to chloride solution of 1:0.8, mounting a potentiometer at the aqueous phase outlet of the first loading reactor to monitor the potential value of the aqueous phase, stopping the introduction of the chloride solution when the potential value drops to 503 mV, where at this time, the first-stage gold-loaded solution was pumped to the reduction reactor for reduction, and the two-stage loading was switched to the first-stage loading; obtaining 745 L of a gold-loaded solution and 596 L of a post-loading solution after the loading, sending the gold-loaded solution containing gold 70.55 g/L and platinum, palladium, and rhodium all<0.001 g/L to the reducer (reduction reactor) for reduction, where the reducing agent was oxalic acid and prepared into 62 L of 85 g/L oxalic acid solution, the reduction temperature was 93° C., and at the end point of the reduction, the gold-loaded solution contained 0.014 g/L of gold; performing static separation when reaching the end point of reduction, standing for 10 min or above to separate the organic phase, performing filtering separation on the crude gold powder mixed with the post-reduction solution to separate 61 L of post-reduction solution and 52.467 kg of sponge gold, with a gold grade of 99.996%, sending the post-reduction solution to the evaporator for evaporating and concentrating to produce a concentrated solution 1 (37 L) and a condensate (706 L), returning the concentrated solution 1 to the reduction process, and returning the condensate to step 1;
step 3: cooling the concentrated solution 1 to 24° C., stirring for crystallization, filtering to obtain a post-crystallization solution and residual oxalic acid, where the post-crystallization solution was returned to the gold loading process in step 2, and the residual oxalic acid was returned to the reduction process of the gold-loaded solution in step 2;
step 4: low-temperature distillation: pumping the post-loading solution in step 2 to the low-temperature vacuum evaporator, controlling the temperature of the liquid in the low-temperature distillation tower to 62° C. and the pressure in the distillation tower to 58 kPa, and distilling out 325 L of low-acid condensate (containing gold 0.0001 g/L, platinum 0.0001 g/L, palladium 0.0001 g/L, rhodium 0.0001 g/L, tellurium 0.08 g/L, selenium 0.539 g/L) and 184 L of high-acid condensate (containing gold<0.0001 g/L, palladium<0.0001 g/L, rhodium<0.0001 g/L, tellurium 0.211 g/L, selenium 1.50 g/L, H+2.2 g/L), where the high-acid condensate was returned to step 1 as the hydrochloric acid input, and the low-acid condensate entered step 6 for washing, and a concentrated solution 2 (87 L) was produced, containing gold 0.042 g/L, platinum 4.116 g/L, palladium 25.68 g/L, rhodium 0.082 g/L, tellurium 36.39 g/L, and selenium 221.04 g/L;
step 5: high-temperature distillation: transferring the concentrated solution 2 in step 4 to a high-temperature evaporator, further raising the temperature to 98° C. and controlling the pressure inside the evaporator to 71 kPa to remove the residual moisture until crystals were formed, to produce a concentrated solution 3;
step 6: directional crystallization and centrifugal filtration: discharging the concentrated solution 3 (62 L) discharged in step 5 and containing gold 0.058 g/L, platinum 5.78 g/L, palladium 36.01 g/L, rhodium 0.114 g/L, tellurium 48.62 g/L, and selenium 309.66 g/L, and cooling to 71° C. for directional crystallization; performing centrifugal filtration to obtain 27.36 kg of crystallized residue (containing gold 0.035%, platinum 0.544%, palladium 4.467%, rhodium 0.023%, tellurium 63.407%, and selenium 3.504%) and 16.83 L of selenious acid (containing gold 0.0004 g/L, platinum 0.04 g/L, palladium 0.159 g/L, and rhodium 0.0067 g/L, tellurium 50.64 g/L, selenium 606.25 g/L); and
step 7: washing the crystallized residue in step 6 with cold water or the low-acid condensate produced in step 4, with the pH controlled to 2-3 during the washing process, filtering after the washing to obtain 5.8 kg of tellurium residue (containing gold<0.0001%, platinum<0.0001, palladium 0.001%, rhodium<0.0001%, tellurium 50.48%, and selenium 14.24%) and a palladium-platinum-rhodium rich solution (containing gold 0.117 g/L, platinum 13.70 g/L, palladium 85.52 g/L, rhodium 0.269 g/L, tellurium 2.65 g/L, and selenium 27.61 g/L).

### Comparative Example 3: Implementation Method

for the components of the waste acid treated in Example 3, the process of dissolution by using an aqueous solution chlorination method to obtain a chloride solution containing precious metals-neutralization to adjust pH-gold precipitation by reduction-ammonium chloropalladate precipitation of platinum and palladium was carried out with the specific operation steps as follows:
(1) adding 60 g/L hydrochloric acid and 22 kg of sodium chlorate at a liquid-to-solid ratio of 6:1, stirring at the temperature controlled at 90° C. for 4 h for dissolution to obtain 596 L of chloride solution (containing gold 82.85 g/L, platinum 0.554 g/L, palladium 3.84 g/L, rhodium 0.011 g/L, tellurium 5.11 g/L, and selenium 25.78 g/L) and 14.2 kg of chloride residue (gold 23.38%, platinum 0.21%, palladium 1.15%, rhodium 0.0059%, tellurium 1.79%, and selenium 31.23%);
(2) neutralizing the chloride solution obtained in step (1) to pH=2 by adding sodium hydroxide, and filtering to obtain 278 L of neutralized solution (containing gold 51.96 g/L, platinum 0.514 g/L, palladium 4.212 g/L, rhodium 0.0236 g/L, tellurium 61.746 g/L, and selenium 5.38 g/L), and 9.2 kg of neutralization residue containing gold 36.50%, platinum 0.136%, palladium 0.835%, rhodium 0.0006%, tellurium 1.72%, and selenium 2.51%;
(3) heating the neutralized solution produced in step (2) to 90° C., adding 15 kg of oxalic acid for reduction to obtain about 46.02 kg of gold powder with a gold grade of 99.9%, and produce 593 L of post-reduction solution; and
(4) slowly adding 6 kg of sodium chlorate to the post-reduction solution produced in step (3), at the temperature controlled at 59° C., to produce 7.2 kg of ammonium chloropalladate containing gold 0.015%, palladium 24.62%, platinum 3.90%, rhodium 0.0476%, tellurium 0.04%, and selenium 0.21%, and produce 591 L of post-palladium-precipitation solution containing gold 0.126 g/L, platinum 0.061 g/L, palladium 0.38 g/L, rhodium 0.005 g/L, tellurium 4.48 g/L, and selenium 25.60 g/L.

### Effect Comparison of Example 3

From a rare and precious material containing selenium 19.2%, tellurium 3.2%, gold 51.1%, platinum 0.35%, palladium 2.17%, and rhodium 0.0071%, 99.99% gold powder was recovered and produced and a palladium-platinum-rhodium rich solution was recovered and obtained. The metal direct recovery rates are as shown in Table 3, where the metal direct recovery rates and recovery rate indicators in Example 3 are comprehensively superior to those in Comparative Example 3. In addition, by using the method of Example 3, no reagents, such as nitric acid, cyanide, sulfur dioxide and alkali, are used, truly achieving the regeneration and reuse of acid and accomplishing the goal of zero discharge. Specific implementation technical and economic indicators were presented in Table 3.

TABLE 3
Comparison of Effects of Example 3 and Comparative Example 3 shown in Following Table:

| | Direct recover rate/% | | | | | |
|---|---|---|---|---|---|---|
| | | Pt | Pd | Rh | | |
| | | (palladium- | (palladium- | (palladium- | | |
| | Au | platinum- | platinum- | platinum- | Se | Te |
| | (sponge | rhodium rich | rhodium rich | rhodium rich | (selenious | (tellurium |
| Item | gold) | solution) | solution) | solution) | acid) | residue) |
| Example 3 | 99.9 | 99.0 | 96.7 | 99.4 | 89.3 | 88.8 |
| Comparative | 87.2 (sponge | 78.06 (ammonium | 79.1 (ammonium | 46.9 (ammonium | 76.4 (palladium | 87.4 (palladium |
| Example 4 | gold) | chloropalladate) | chloropalladate) | chloropalladate) | precipitation | precipitation |
| | | | | | solution) | solution) |

To further demonstrate the beneficial effects of the present application for better understanding of the present application, the technical features disclosed in the present application are further illustrated through the following comparative examples, which cannot be construed as limiting the present application. Other improvements made by those skilled in the art based on the above invention content without inventive work are also deemed to fall within the scope of protection of the present application.

The above description of the disclosed embodiments enables one skilled in the art to implement or use the present application. Various modifications to these embodiments will be apparent to one skilled in the art, and the general principles defined herein may be implemented in other embodiments without departing from the spirit or scope of the present application. Therefore, the present application is not limited to the embodiments shown herein but is intended to conform to the widest scope consistent with the principles and novel features disclosed herein.

The above embodiments are only used to illustrate the technical solutions of the present application, rather than to limit them; although the present application has been described in detail with reference to the aforementioned embodiments, those skilled in the art should understand that they can still modify the technical solutions described in the aforementioned embodiments, or make equivalent replacements for some of the technical features therein, and these modifications or replacements do not deviate the essence of the corresponding technical solutions from the spirit and scope of the technical solutions of the embodiments of the present application.

### INDUSTRIAL APPLICABILITY

The present application has strong adaptability to components of the complex material containing gold, platinum, palladium, rhodium, selenium, and tellurium, and is particularly suitable for materials with high selenium and tellurium contents and low precious metal contents, can obtain high direct recovery rates and recovery, and can separate selenium and tellurium from the solution to obtain a precious solution with high concentrations of platinum, palladium, rhodium and rhodium, facilitating the further extraction of these metals.

1. A full hydrometallurgical process for recovering multiple metals from a complex rare and precious material, comprising the following steps:
step 1: chlorination and dissolution: adding a hydrochloric acid aqueous solution and the complex rare and precious material to a reactor, stirring for reaction during which a temperature is raised to 60-70° C. and an oxidant is slowly added, adding a small amount of the complex rare and precious material again after the reaction is completed, stirring to remove chlorine, stopping stirring for clarification, then extracting an upper clear liquid of a chloride solution for entering gold loading, wherein a precipitated chloride residue is used as a raw material for silver recovery, wherein technical conditions are controlled as: a concentration of the hydrochloric acid aqueous solution of 5-7 mol/L, a liquid-to-solid ratio of 3-6:1, and an oxidation process temperature of 80-95° C.;
step 2: the gold loading: performing two-stage countercurrent gold loading to obtain a gold-loaded solution and a post-loading solution after loading of the chloride solution, performing reduction on the gold-loaded solution, performing static separation when reaching an end point of the reduction for clarifying to separate an organic phase, and filtering a precipitate to separate a post-reduction solution and sponge gold; and evaporating and concentrating the post-reduction solution to produce a concentrated solution 1 and a condensate;
step 3: cooling the concentrated solution 1 in step 2 to <30° C., stirring for crystallization, and filtering to obtain a post-crystallization solution and residual oxalic acid, wherein the post-crystallization solution is returned to the gold loading process in step 2, and the residual oxalic acid is returned to the reduction process of the gold-loaded solution in step 2;
step 4: low-temperature distillation: performing low-temperature distillation on the post-loading solution in step 2 to distill out a low-acid condensate and a high-acid condensate, wherein a temperature of a liquid in a low-temperature distillation tower is controlled to be 60-75° C., and a pressure in the distillation tower to be 55-65 kPa, the high-acid condensate is returned to step 1 as a hydrochloric acid input, and the low-acid condensate enters step 6 for washing, and a post-distillation residual solution is a concentrated solution 2;
step 5: high-temperature distillation: performing high-temperature distillation on the concentrated solution 2 in step 4 to remove residual moisture to obtain a concentrated solution 3, wherein a temperature of the high-temperature distillation is 90-100° C. and a pressure in an evaporator is 60-80 kPa;
step 6: directional crystallization and centrifugal filtration: performing directional crystallization and centrifugal filtration on the concentrated solution 3 to obtain crystallized residue and selenious acid; and
step 7: washing: washing the crystallized residue with cold water or the low-acid condensate produced in step 4, and filtering to obtain tellurium residue and a palladium-platinum-rhodium rich solution.

2. The full hydrometallurgical process for recovering multiple metals from a complex rare and precious material according to claim 1, wherein components of the complex rare and precious material comprise, by mass percentage, selenium 3-20%, tellurium 3-40%, gold≥1%, platinum≥0.1%, palladium≥0.1%, rhodium≥0.005%, and other impurities<30%, and the selenium, tellurium, gold, platinum, palladium and rhodium each exist in a form of elemental phase.

3. The full hydrometallurgical process for recovering multiple metals from a complex rare and precious material according to claim 1, wherein in step 2, an operation of the gold loading comprises: controlling a flow rate ratio of the loading agent to the chloride solution to be 1:0.8~8, performing countercurrent gold loading by using a loading counter tower 1 and a loading tower 2 and adopting a two-stage loading reactor to obtain the gold-loaded solution and the post-loading solution after loading, sending the gold-loaded solution to a reduction reactor for reduction, and performing static separation when reaching the end point of the reduction, standing for 10 min or above for clarifying to separate the organic phase, and filtering the precipitate to separate the post-reduction solution and the sponge gold; and evaporating and concentrating the post-reduction solution to produce the concentrated solution 1 and the condensate; and returning the concentrated solution 1 to the reduction process, and returning the condensate to step 1 to supplement the hydrochloric acid aqueous solution.

4. The full hydrometallurgical process for recovering multiple metals from a complex rare and precious material according to claim 1, wherein the two-stage loading reactor in step 2 comprises a first-stage loading reactor and a second-stage loading reactor, a potentiometer is mounted at an aqueous phase outlet of the first-stage loading reactor to monitor a potential value of the aqueous phase, and when the potential value drops to <520 mV, introduction of the chloride solution is stopped, and at this time, a first-stage gold-loaded solution is pumped to the reduction reactor for reduction, and the second-stage loading reactor is switched to be the first-stage loading reactor.

5. The full hydrometallurgical process for recovering multiple metals from a complex rare and precious material according to claim 1, wherein in step 2, the gold-loaded solution is fed into the reactor for reduction, with a temperature controlled at 90-95° C., the gold-loaded solution at the end point of the reduction comprises<0.1 g/L of gold, and in step 2, a reducing agent for the reduction is oxalic acid.
